(19) United States
(12) Patent Application Publication
(10) Pub. No.: US 2025/0390701 A1
(43) Pub. Date: Dec. 25, 2025

(54) TENSOR PROCESSING METHOD, ELECTRONIC DEVICE AND STORAGE MEDIUM

(71) Applicant: Beijing Baidu Netcom Science Technology Co., Ltd., Beijing (CN)

(72) Inventors: Jianzhong LIANG, Beijing (CN); Yichen ZHANG, Beijing (CN); Mingdong WANG, Beijing (CN); Qiuliang CHEN, Beijing (CN); Jiabin YANG, Beijing (CN); Dianhai YU, Beijing (CN); Haifeng WANG, Beijing (CN)

(21) Appl. No.: 18/821,075

(22) Filed: Aug. 30, 2024

(30) Foreign Application Priority Data
Jun. 20, 2024 (CN) 202410796913.2

(51) Int. Cl. G06N 3/04

(52) U.S. Cl. CPC G06N 3/04

(57) ABSTRACT

Provided is a tensor processing method, an electronic device, and a storage medium, relating to the fields of deep learning and artificial intelligence. The method includes: determining relevant information of a conversion function corresponding to each of one or more target input tensors of a first operator in a target computation graph based on computation logic of the first operator and source split states of at least part of source input tensors of the first operator; splitting each source input tensor of the first operator based on the relevant information of the conversion function corresponding to each target input tensor to obtain each target input tensor; and sending each target input tensor to a plurality of computing devices. The plurality of computing devices are configured to perform distributed parallel communication based on each target input tensor and the first operator, to obtain an output tensor of the first operator.

### CROSS-REFERENCE TO RELATED APPLICATIONS

The present application claims the priority from Chinese Patent Application No. 202410796913.2, filed with the Chinese Patent Office on Jun. 20, 2024, the content of which is hereby incorporated herein by reference in its entirety.

### TECHNICAL FIELD

The present disclosure relates to the field of computer technology, and in particular to the fields of deep learning, artificial intelligence and other technologies.

### BACKGROUND

In the field of deep learning, large models show better effects than small models, and the distributed parallel training framework is a prerequisite for implementing large model training. Generally, the threshold for using the distributed parallel training framework is relatively high, so a semi-automatic parallel framework has emerged. In this semi-automatic parallel framework, a user only needs to mark the logical split states of some tensors on a computation graph, and the deep learning framework can convert the computation graph into a distributed parallel computation graph for parallel training based on the user's markings. The computation graphs include two types: dynamic graph and static graph. However, there are differences in running logic of the dynamic graph and static graph. The execution logic and call stack of the deep learning framework in the dynamic graph and static graph are quite different, resulting in different types of computation graphs composed of the same operators, and resulting in inconsistent results. This will cause the user to repeatedly adjust or repeatedly execute the computation graph, thereby causing the problem of wasting the processing resources of a plurality of computing devices or reducing the resource utilization of the plurality of computing devices. Therefore, how to ensure the consistency of execution results in different types of computation graphs composed of the same operators becomes a problem that needs to be solved.

### SUMMARY

The present disclosure provides a tensor processing method and apparatus, an electronic device and a storage medium.

According to one aspect of the present disclosure, provided is a tensor processing method, including:
determining relevant information of a conversion function corresponding to each of one or more target input tensors of a first operator in a target computation graph based on computation logic of the first operator and source split states of at least part of source input tensors of the first operator, where relevant information of a conversion function corresponding to any of the one or more target input tensors is constant when the target computation graph is a computation graph in different types;
splitting each source input tensor of the first operator based on the relevant information of the conversion function corresponding to each target input tensor to obtain each target input tensor; and
sending each target input tensor to a plurality of computing devices, where the plurality of computing devices are configured to perform distributed parallel communication based on each target input tensor and the first operator, to obtain an output tensor of the first operator.

According to one aspect of the present disclosure, provided is a tensor processing apparatus, including:
a conversion function determining module configured to determine relevant information of a conversion function corresponding to each of one or more target input tensors of a first operator in a target computation graph based on computation logic of the first operator and source split states of at least part of source input tensors of the first operator, where relevant information of a conversion function corresponding to any of the one or more target input tensors is constant when the target computation graph is a computation graph in different types;
a tensor splitting module configured to split each source input tensor of the first operator based on the relevant information of the conversion function corresponding to each target input tensor to obtain each target input tensor; and
a communication module configured to send each target input tensor to a plurality of computing devices, where the plurality of computing devices are configured to perform distributed parallel communication based on each target input tensor and the first operator, to obtain an output tensor of the first operator.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method of any embodiment of the present disclosure.

According to yet another aspect of the present disclosure, provided is a computer program product including a computer program, and the computer program implements the method of any embodiment of the present disclosure, when executed by a processor.

Through the above solution, regardless of whether the target computation graph is a static or dynamic computation graph, since the same relevant information of the conversion function of the target input tensor can be determined for the same operator, it can be ensured that the target input tensor in the same split state can be obtained regardless of whether the computation graph is executed statically or dynamically after the source input tensor is split based on the conversion function corresponding to the target input tensor. Ultimately, it is ensured that the target input tensor in the same split state is sent to a plurality of computing devices to perform the same distributed parallel communication regardless of whether the computation graph is executed statically or dynamically, thus ensuring the consistency of the final result. In this way, no matter in the dynamic computation graph or the static computation graph, the model networking for the same operator will get the consistent running result, avoiding the repeated adjustment or repeated execution of the computation graph, and thereby avoiding the problem of wasting the processing resources of the plurality of computing devices or reducing the resource utilization of the plurality of computing devices caused by the repeated execution of the computation graph.

### BRIEF DESCRIPTION OF THE DRAWINGS

The accompanying drawings are used to better understand the present solution, and do not constitute a limitation to the present disclosure.

FIG. 1 is a schematic flowchart of a tensor processing method according to an embodiment of the present disclosure;

FIG. 2 is a schematic diagram of a conversion scenario of an input tensor of an operator according to an embodiment of the present disclosure;

FIG. 3 is a schematic diagram of a processing scenario of a conversion function according to an embodiment of the present disclosure;

FIG. 4 is a schematic flowchart of a tensor processing method according to another embodiment of the present disclosure;

FIG. 5 is a schematic diagram of a composition structure of a tensor processing apparatus according to an embodiment of the present disclosure;

FIG. 6 is a schematic diagram of a composition structure of a tensor processing apparatus according to another embodiment of the present disclosure;

FIG. 7 is a schematic diagram of a composition structure of a tensor processing apparatus according to yet another embodiment of the present disclosure; and

FIG. 8 is a block diagram of an electronic device for implementing the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

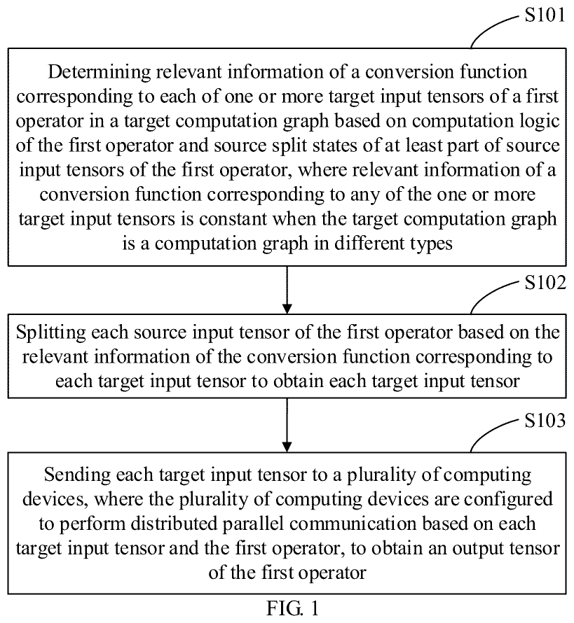

In one aspect of the present disclosure, an embodiment provides a tensor processing method, as shown in FIG. 1, including:

S101: determining relevant information of a conversion function corresponding to each of one or more target input tensors of a first operator in a target computation graph based on computation logic of the first operator and source split states of at least part of source input tensors of the first operator, where relevant information of a conversion function corresponding to any of the one or more target input tensors is constant when the target computation graph is a computation graph in different types.

S102: splitting each source input tensor of the first operator based on the relevant information of the conversion function corresponding to each target input tensor to obtain each target input tensor.

S103: sending each target input tensor to a plurality of computing devices, where the plurality of computing devices are configured to perform distributed parallel communication based on each target input tensor and the first operator, to obtain an output tensor of the first operator.

The tensor processing method provided in this embodiment may be applied to an electronic device, and the electronic device may be a server or a computer; and further, a deep learning framework may be set in or capable of running in the electronic device.

In an embodiment of the present application, the target computation graph is a computation graph for model networking, the target computation graph may be provided with or include one or more operators of model networking, and the target computation graph can be used to determine or obtain the structure and/or function of a target model. In other words, the target computation graph can construct the structure of one target model, and the target model can be trained and/or finally obtained by running the target computation graph. The target model may be applied to a variety of possible fields, such as at least one of speech processing, image processing, data processing, text processing, etc. The fields to which the target model may be applied are not limited or enumerated here.

The computation graph may be of two types: static and dynamic. The target computation graph may be either of static computation graph and dynamic computation graph. Here, the dynamic computation graph (or simply dynamic graph) refers to a computation graph that can execute each operator in the model network immediately. That is, every time a user sets an operator in the dynamic graph, the operator will be executed immediately through the call stack corresponding to the dynamic graph. The static computation graph (or simply static graph) may include all operators (multiple operators) in the model network, that is, all operators in the model network are recorded in the static graph. When the static graph is executed, the granularity of the entire static graph is scheduled and executed through the call stack corresponding to the static graph. The call stack corresponding to the dynamic graph is different from the call stack corresponding to the static graph.

Tensors may be basic data structures in deep learning and may include the following types: input data, model parameter, and output data; and the input data may include sample data, label, etc. The input tensors involved in the embodiments of the present application may include at least one of: sample data, label, model parameter, etc.

Thus, regardless of whether the target computation graph is a static or dynamic computation graph, since the same relevant information of the conversion function of the target input tensor can be determined for the same operator, it can be ensured that the target input tensor in the same split state can be obtained regardless of whether the computation graph is executed statically or dynamically after the source input tensor is split based on the conversion function corresponding to the target input tensor. Ultimately, it is ensured that the target input tensor in the same split state is sent to a plurality of computing devices to perform the same distributed parallel communication regardless of whether the computation graph is executed statically or dynamically, thus ensuring the consistency of the final result. In this way, no matter in the dynamic computation graph or the static computation graph, the model networking for the same operator will get the consistent running result, avoiding the repeated adjustment or repeated execution of the computation graph, and thereby avoiding the problem of wasting the processing resources of the plurality of computing devices or reducing the resource utilization of the plurality of computing devices caused by the repeated execution of the computation graph.

In some possible implementations, before determining the relevant information of the conversion function corresponding to each of one or more target input tensors of the first operator in the target computation graph based on the computation logic of the first operator and the source split states of at least part of the source input tensors of the first operator, the method further includes at least one of: when the target computation graph is a dynamic computation graph, in response to obtaining a distributed split mark set for an i^{th} source input tensor of the first operator, obtaining a source split state of the i^{th} source input tensor of the first operator based on the distributed split mark corresponding to the i^{th} source input tensor of the first operator, where i is an integer not less than 1, and the i^{th} source input tensor is one of at least part of the source input tensors; and when the target computation graph is the dynamic computation graph, in response to setting a k^{th} output tensor of a third operator in the target computation graph as the i^{th} source input tensor of the first operator, taking a split state corresponding to the k^{th} output tensor of the third operator as the source split state of the i^{th} source input tensor of the first operator, where k is an integer not less than 1.

In this implementation, the type of the target computation graph is a dynamic computation graph, and the target computation graph may be alternatively referred to as target dynamic computation graph or target dynamic graph. In the embodiments of the present application, the meanings of the target dynamic computation graph, the target dynamic graph, and the target computation graph being a dynamic computation graph are the same, and will not be explained repeatedly below.

The i^{th} source input tensor of the first operator may be any source input tensor of the first operator.

In one example, the distributed split mark corresponding to the i^{th} source input tensor of the first operator may be set by the user in the target dynamic computation graph.

When the user uses the dynamic graph pattern for model networking (non-distributed), the semi-automatic parallel API (Application Programming Interface) is used for distributed split marks of some source input tensors in the model in the networking of the target dynamic graph. Specifically, the user may set the current operator in the target dynamic graph, and the current operator is the first operator in this implementation; and the user may also set the distributed split mark of each source input tensor in at least part of the source input tensors of the current operator in the target dynamic graph, where the i^{th} source input tensor refers to any source input tensor of the current operator (i.e., the first operator) for which the user has set the distributed split mark. It should be noted that the user may set corresponding distributed split marks for some or all of the source input tensors of the current operator (i.e., the first operator).

Taking the first operator being an MATMUL operator (an operator performing matrix multiplication operation) as an example, it is assumed that the MATMUL operator has two source input tensors, namely source input tensor A and source input tensor B. Here, the user may only set the distributed split mark of the source input tensor A, and do not set the distributed split mark of the source input tensor B.

The step of obtaining the source split state of the i^{th} source input tensor of the first operator based on the distributed split mark corresponding to the i^{th} source input tensor of the first operator may be: taking the content of the distributed split mark corresponding to the i^{th} source input tensor of the first operator as the source split state of the i^{th} source input tensor of the first operator.

The distributed split mark corresponding to the i^{th} source input tensor may be configured according to actual requirements. For example, the content of the distributed split mark corresponding to the i^{th} source input tensor may include: the topology information of a distributed cluster, and an indication of whether to split the i^{th} source input tensor in multiple dimensions.

Here, the distributed cluster may include one or more computing devices (the computing devices may be referred to as devices for short), and the topology information of the distributed cluster may be used to represent information of a multi-dimensional topology composed of the one or more computing devices. For example, it is assumed that the distributed cluster includes 8 computing devices, which are Device 0 to Device 7 respectively. The 8 computing device constitute a two-dimensional topology, that is, every 4 computing devices constitute one dimension (or one path). The topology information of the distributed cluster may include [0,1,2,3] [4,5,6,7], that is, Device 0 to Device 3 constitute one dimension, and Device 4 to Device 7 constitute one dimension.

The indication of whether to split may be represented by a corresponding indication value. For example, a first indication value may be used to indicate splitting, and a second indication value may be used to indicate not splitting. The first indication value and the second indication value are different. The specific values of the first indication value and the second indication value may be configured according to actual conditions. For example, the first indication value may be 0, and the second indication value may be −1. It should be understood that this is only an exemplary illustration. As long as the first indication value and the second indication value are different, they are within the protection scope of this embodiment and are not limited or exhaustive here.

Further, multiple dimensions of the i^{th} source input tensor may be set according to actual conditions. For example, the i^{th} source input tensor may include two dimensions, the first dimension represents row, and the second dimension represents column. For example, assuming that the indication of whether to split the i^{th} source input tensor in two dimensions is [−1,0], it means that the i^{th} source input tensor is not split in the first dimension but is split in the second dimension, that is, the i^{th} source input tensor is not split in row but is split in column.

Alternatively, the indication of whether to split may be used to indicate whether to perform numerical splitting, that is, such splitting indication is not used to indicate dimensional (or shape) splitting, but is used to indicate numerical splitting of elements. For example, assuming that the i^{th} source input tensor includes 4 elements [1,2,3,4] in two dimensions, if the indication of whether to split indicates numerical splitting, the i^{th} source input tensor may be split into two splitting results of [0,1,2,3] and [1,1,1,1] with the same shape or dimension but different values.

It should be pointed out that, if the user sets distributed split marks corresponding to a plurality of source input tensors of the current operator (i.e., the first operator) in the target dynamic computation graph, the processing or related illustration for each source input tensor is the same as that for the i^{th} source input tensor mentioned above, and thus will not be described one by one.

In one example, the user does not set a corresponding distributed split mark for the i^{th} source input tensor of the first operator. In the target dynamic graph, the first operator (i.e., the current operator) serves as a downstream operator of a third operator that has been executed (the third operator may also be called an upstream operator of the current operator). The split state of the k^{th} output tensor of the third operator may be directly used as the source split state of the i^{th} source input tensor of the first operator. The source split state of the i^{th} source input tensor may contain content similar to that in the preceding example, and will not be described again. It should be noted that the third operator may have one or more output tensors, and the k^{th} output tensor is any one of all output tensors of the third operator. It should also be pointed out that the first operator may not only have one upstream operator, namely the third operator, but may also have one or more other upstream operators. If an output tensor of any other upstream operator is also used as a source input tensor of the first operator, the split state of this output tensor may also be used as the source split state of the source input tensor of the first operator. There will be no enumeration or repetition here.

In the actual process, the first operator may include one or more source input tensors. The way to determine the source split state of any source input tensor of the first operator is the same as any way to determine the source split state of the i^{th} source input tensor described above, and will not be described here one by one. For example, it is assumed that the first operator is an MATMUL operator, and the source input tensors include a source input tensor A and a source input tensor B, where the user can set the distributed split mark of the source input tensor A; the first operator also has an upstream operator, and the upstream operator has a plurality of output tensors, one of which is output tensor C as the source input tensor B of the first operator, and then the split state of the output tensor C is used as the source split state of the source input tensor B.

Thus, when the target computation graph is a dynamic computation graph, the source split states of at least part of the source input tensors of the first operator can be determined based on the distributed split marks set for at least part of the source input tensors of the first operator, or the source split state of a source input tensor of the first operator can be determined based on the split state of an output tensor of the upstream operator of the first operator, thereby obtaining the accurate initial split state corresponding to the input tensor of the operator under the dynamic graph, and providing the accurate information for accurately obtaining the target split state of the input tensor later.

In some possible implementations, the target computation graph is a static computation graph, and the method further includes: generating the target computation graph based on an original dynamic computation graph in response to obtaining a static conversion instruction under the original dynamic computation graph, where the target computation graph and the original dynamic computation graph contain a plurality of same operators and distributed split marks of one or more source input tensors of the plurality of operators, and the plurality of operators include the first operator.

In this implementation, each operator in the original dynamic computation graph is set in a similar way to the current operator in the aforementioned implementation, or the target dynamic graph in the aforementioned implementation may be used as the original dynamic computation graph in this implementation.

Furthermore, the aforementioned implementation has also explained that the user may also set the distributed split mark(s) of one or more source input tensors of the current operator when setting the current operator in the original dynamic computation graph. In this implementation, all the operators and the distributed split marks of at least part of the source input tensors in all the operators set by the user in the original dynamic computation graph are converted and recorded into the operators or input tensors in the target computation graph (referred to as the target static computation graph or the target static graph).

The plurality of operators include the first operator. The distributed split marks of one or more source input tensors of the plurality of operators may include the distributed split marks of at least part of the source input tensors of the first operator, or may not include the distributed split marks of the source input tensors of the first operator.

It should be pointed out that, as mentioned in the aforementioned implementations, the user may not set the distributed split marks of the source input tensors for the current operator, but directly use the split state of an output tensor of an upstream operator of the current operator as the source split state of a source input tensor of the current operator. However, the source split state of the source input tensor not set by the user is not converted to the target static computation graph.

In this way, the plurality of operators and the distributed split marks of one or more source input tensors of the plurality of operators can be obtained in both the static computation graph and the dynamic computation graph, thereby ensuring that no matter in a static or dynamic computation graph, as long as a static computation graph is converted from a corresponding original dynamic computation graph, the static computation graph and its corresponding original dynamic computation graph both use the same distributed split marks for subsequent processing.

Before determining the relevant information of the conversion function corresponding to each of one or more target input tensors of the first operator in the target computation graph based on the computation logic of the first operator and the source split states of at least part of the source input tensors of the first operator, the method further includes at least one of: when an i^{th} source input tensor of the first operator has a corresponding distributed split mark, obtaining a source split state of the i^{th} source input tensor of the first operator based on the distributed split mark corresponding to the i^{th} source input tensor of the first operator, where i is an integer not less than 1, and the i^{th} source input tensor is one of at least part of the source input tensors; and when the i^{th} source input tensor of the first operator in the target computation graph is a k^{th} output tensor of a third operator, taking a split state corresponding to the k^{th} output tensor of the third operator as the source split state of the i^{th} source input tensor of the first operator, where k is an integer not less than 1.

In this embodiment, the type of the target computation graph is a static computation graph, that is, the target computation graph may be a target static computation graph (or referred to as a target static graph). In the embodiments of the present application, the meanings of the target static computation graph, the target static graph, and the target computation graph being a static computation graph are the same, and will not be explained repeatedly below.

In one example, the distributed split mark corresponding to the i^{th} source input tensor of the first operator may be recorded in the target static computation graph.

The number of all source input tensors of the first operator may be one or more. In this example, the i^{th} source input tensor refers to a source input tensor recorded with a distributed split mark, that is, only some source input tensors among all the source input tensors of the first operator may be recorded with corresponding distributed split marks.

The distributed split mark corresponding to the i^{th} source input tensor may include the same content as that in the aforementioned embodiment, which will not be described again. The process of obtaining the source split state of the i^{th} source input tensor of the first operator based on the distributed split mark corresponding to the i^{th} source input tensor of the first operator is also the same as that in the aforementioned embodiment, and will not be described again.

It should be pointed out that, if a plurality of source input tensors of the first operator are respectively recorded with corresponding distributed split marks, the processing or related illustration for each source input tensor is the same as that for the i^{th} source input tensor mentioned above, and thus will not be described one by one.

In one example, the first operator in the target static computation graph may have one or more upstream operators, and the third operator may be any upstream operator of the first operator; and correspondingly, the first operator may be any one of one or more downstream operators of the third operator. When the k^{th} output tensor of the third operator has a corresponding split state, the split state of the k^{th} input tensor of the third operator may be directly used as the source split state of the i^{th} source input tensor of the first operator. The source split state of the i^{th} source input tensor may contain content similar to that in the preceding example, and will not be described again.

In some possible examples, some source input tensors of the first operator may be determined by the distributed split marks set by the user, and/or the source split marks of some source input tensors of the first operator are the split marks of the output tensors derived from an upstream operator.

Thus, when the target computation graph is a static computation graph, the source split states of at least part of the source input tensors of the first operator can be determined based on the distributed split marks recorded for at least part of the source input tensors of the first operator, or the source split state of a source input tensor of the first operator can be determined based on the split state of the output tensor of the upstream operator of the first operator, thereby obtaining the accurate initial split state corresponding to the input tensor of the operator under the static computation graph, and providing the accurate information for accurately obtaining the target split state of the input tensor later.

In some possible implementations, the step of determining the relevant information of the conversion function corresponding to each of one or more target input tensors of the first operator in the target computation graph based on the computation logic of the first operator and the source split states of at least part of the source input tensors of the first operator, includes: deriving a target split state of each of the one or more target input tensors of the first operator based on the computation logic of the first operator in the target computation graph and the source split states of at least part of the source input tensors of the first operator; and determining the relevant information of the conversion function corresponding to each target input tensor of the first operator based on the target split state of each target input tensor of the first operator.

In this implementation, the type of the target computation graph may be a dynamic computation graph or a static computation graph, that is, the processing provided in this implementation may be executed regardless of whether the target computation graph is a target dynamic computation graph or a target static computation graph. The first operator may refer to a current operator set by the user in the target dynamic computation graph, or an operator for which the split state is currently derived among all operators in the target static computation graph.

In this way, for the input tensor of the operator in the target computation graph, the target split state of the target input tensor of the operator can be determined based on the computation logic of the operator and the source split state of the input tensor, and then one or more conversion functions for converting the target input tensor are obtained. Also, the conversion function corresponding to the target input tensor is the same regardless of whether the type of the target computation graph is a static computation graph or a dynamic computation graph. Thus, it can be ensured that the same split state of the target input tensor can be determined and the same conversion function can be ultimately determined for the same operator regardless of whether the target computation graph is a static or dynamic computation graph, so it can be ensured that the same result can be obtained regardless of whether the computation graph is executed statically or dynamically.

In some possible implementations, the step of deriving the target split state of each of the one or more target input tensors of the first operator based on the computation logic of the first operator in the target computation graph and the source split states of at least part of the source input tensors of the first operator, includes: deriving the target split state of each of the one or more target input tensors of the first operator and a split state of the output tensor of the first operator based on the computation logic of the first operator, the source split states of at least part of the source input tensors of the first operator and a preset split constraint of the first operator in the target computation graph, where the preset split constraint of the first operator is constant when the target computation graph is a computation graph in different types, and the preset split constraint of the first operator includes at least one of: target split states of the one or more target input tensors satisfy a computation requirement of the first operator, and an efficiency requirement for distributed parallel communication is performed based on the target split states of the one or more target input tensors of the first operator.

The step of deriving the target split state of each of the one or more target input tensors of the first operator based on the computation logic of the first operator, the source split states of at least part of the source input tensors of the first operator and the preset split constraint of the first operator in the target computation graph may be: deriving the target split state of each of all target input tensors of the first operator based on the computation logic of the first operator, the source split state of each of all source input tensors of the first operator and the preset split constraint of the first operator in the target computation graph.

The first operator may have one or more source input tensors with distributed split marks set or recorded, and/or source split states of one or more source input tensors determined from the split states of one or more output tensors of one or more upstream operators. In addition to the two cases described above, the first operator may also have remaining source input tensors without split states, i.e., source input tensors that do not have distributed split marks set or recorded and do not inherit the split states of the output tensors of the upstream operators. When performing the process of deriving the target split states of one or more target input tensors of the first operator provided in this embodiment, the default split state may be used as the source split states of these source input tensors without split states. Here, the default split state may be configured according to actual conditions. For example, all dimensions are not split by default, or all dimensions are split by default, or the first specified dimension is split and the second specified dimension is not split by default, etc. All possible examples of the default split state are not limited or enumerated here.

The preset split constraint of the first operator specifically includes split legality requirement of the first operator and/or computational efficiency requirement of the first operator.

Here, the split legality requirement of the first operator is that the target split states of the one or more target input tensors meet the efficiency requirement of the first operator. That is to say, after the target input tensors derived by the solution provided in the present application are input into the first operator, it can be ensured that the first operator correctly performs the calculation, that is, the split legality requirement of the first operator is met.

The computational efficiency requirement of the first operator is an efficiency requirement for performing distributed computation based on the target split states of the one or more target input tensors of the first operator.

Specifically, the efficiency requirement for performing distributed computation based on the target split states of the one or more target input tensors of the first operator may include at least one of: a requirement for no redundancy in performing distributed parallel communication based on the target split states of the one or more target input tensors of the first operator; a requirement for the minimum amount of communication in performing distributed parallel communication based on the target split states of the one or more target input tensors of the first operator; and a requirement for the minimum storage space and/or minimum processing resources occupied in performing distributed parallel communication based on the target split states of the one or more target input tensors of the first operator. Here, the storage space may include at least one of a video memory, a memory, etc.; and the processing resource may include at least one of a CPU (Central Processing Unit), a GPU (Graphics Processing Unit), etc.

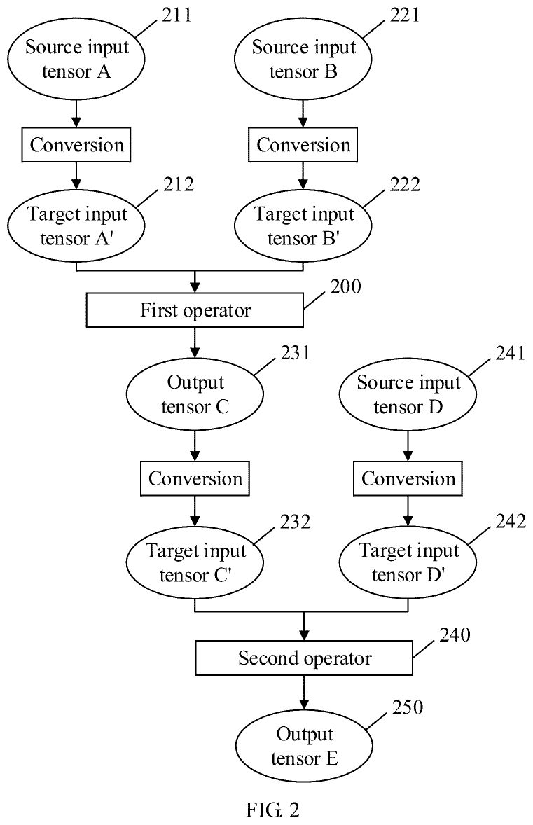

Taking FIG. 2 as an example, the first operator 200 is an MATMUL operator. If the MATMUL operator has two input tensors, the split state of the second dimension of the first input tensor in the two input tensors is required to be the same as the split state of the first dimension of the second input tensor; and it is assumed that the source split state of the source input tensor A 211 of the MATMUL operator in two dimensions is [−1,−1], and the source split state of the source input tensor B 221 in two dimensions is [0,−1]. There may be two processing ways that meet the split legality requirement of the first operator: in the first processing way, the target split state of the target input tensor A′ 212 of the MATMUL operator in two dimensions is [−1,0], and the target split state of the target input tensor B′ 222 in two dimensions is [0,−1]; in the second processing way, the target split state of the target input tensor A′ of the MATMUL operator in two dimensions is [−1,−1], and the target split state of the target input tensor B′ in two dimensions is [−1,−1].

However, in regard to the two processing ways described above, neither of the two target input tensors is split in the second processing way, and then there will be redundant computation in the distributed parallel communication process where two or two groups of computing devices execute the first operator based on two identical target input tensors, so the second processing way meets the split legality requirement of the first operator but does not meet the computation efficiency requirement of the first operator; the two target input tensors are split accordingly in the first processing way, and then the redundant computation can be avoided in the distributed computing process where two or two groups of computing devices execute the first operator based on two split target input tensors, so the first processing way meets the split legality requirement of the first operator and the computation efficiency requirement of the first operator.

The split state of the output tensor of the first operator may be derived by: deriving the split state of the output tensor of the first operator based on the target split states of one or more target input tensors of the first operator and the calculation logic of the first operator. Since the same preset split constraint is used to obtain the target split state of the target input tensor in any type of computation graph, the calculation logic of the first operator is also the same in different types of computation graphs, and thus the same split state of the output tensor of the first operator can be derived in different types of computation graphs.

The number of output tensors of the first operator may be one or more, and the split state of the output tensor of the first operator may refer to the split state of each output tensor of the first operator.

Still taking FIG. 2 as an example, the target split state of the target input tensor A′ 212 of the first operator 200 (i.e., the MATMUL operator) in two dimensions is [−1, 0], and the target split state of the target input tensor B′ 222 in two dimensions is [0,−1]. The MATMUL operator includes an output tensor C 231, which may also include two dimensions, and the split state in the two dimensions is {[−1,−1], Partial}, where Partial is used to represent a partial value of the output tensor that can be obtained by the MATMUL operator in each of two dimensions when the target split state of the target input tensor A in two dimensions is [−1,0] and the target split state of the target input tensor B in two dimensions is [0,−1].

Exemplarily, assuming that all tensors and operators in the target computation graph (regardless of static or dynamic type) need to have certain split states, each device (process) needs to determine the communication and split operations required during the execution of the current operator according to the source split states of the current operator (i.e., the first operator) and the source input tensor. Through the split derivation performed in the above process, the target split state (for example, which can be expressed as Operator DistAttr (Disseminate Attribute)) of the current operator (i.e., the first operator) can be derived according to the source split state of the source input tensor (for example, the split state can be expressed as Tensor DistAttr) and the operation logic of the current operator (i.e., the first operator) itself. The split state of the current operator (i.e., the first operator) determines the communication and split operations required during the execution of the operator; and the output tensor is used as an input tensor of the next operator in the target computation graph and participates in the split derivation of the next operator.

The above split state may be used to describe the cluster and split of the tensor (such as the above-mentioned source input tensor). For example, the source split state of any source input tensor may be expressed as {mesh=[[0,1,2,3], [4,5,6,7]], dims_mapping: [−1,0]}, where “mesh” is used to represent a distributed cluster, [[0,1,2,3], [4,5,6,7]] means that Device 0 to Device 3 constitute one dimension and Device 4 to Device 7 constitute one dimension in the distributed cluster, “dims_mapping” represents splitting the tensor in shape, and the splitting in shape may be splitting in dimension. The specific meanings of “−1” and “0” described above are the same as those in the previous embodiments and will not be described again.

The target split state (OperatorDistAttr) of the first operator can be used to describe the distributed cluster where the first operator is located, the target split state of the required target input tensor, and the split state of the output tensor. For example, the target split state of the first operator can be expressed as {mesh=[[0,1,2,3], [4,5,6,7]], X's dims_mapping: [−1,0], Y's dims_mapping: [0,−1], Out's dims_mapping: [−1,−1]}, where the meaning of “mesh” is the same as above and is not repeated here, “X's” represents one target input tensor, “Y's” represents another target input tensor, “Out's” represents the output tensor, and the meaning of “dims_mapping” is not repeated here.

In this way, by pre-configuring the corresponding split constraint for the operator, the target split state of the input tensor of the operator finally derived can meet the legality requirement and/or efficiency requirement of the operator. Also, since the split constraint pre-configured for the operator are the same in different types of computation graphs, it can be ensured that the same rule can be used to determine the same target split state for the same operator regardless of the type of computation graph, thereby ensuring the consistency of execution results in different computation graphs.

In some possible implementations, the step of determining the relevant information of the conversion function corresponding to each of one or more target input tensors of the first operator in the target computation graph based on the computation logic of the first operator and the source split states of at least part of the source input tensors of the first operator, may include: determining the relevant information of the conversion function corresponding to the n^{th} target input tensor of the first operator based on the split conversion rule of the first operator, the target split state of the n^{th} target input tensor of the first operator, the source split state of the n^{th} source input tensor, and the n^{th} source input tensor, where n is an integer not less than 1, the n^{th} target input tensor is any one of the one or more target input tensors, and the n^{th} source input tensor corresponds to the n^{th} target input tensor.

The relevant information of the conversion function corresponding to the n^{th} target input tensor is constant when the target computation graph is a computation graph in different types. The conversion function corresponding to the n^{th} target input tensor is used to convert the n^{th} source input tensor into the n^{th} target input tensor.

The split conversion rule may include a correspondence between each of one or more conversion functions and the target split state, source split state and source input tensor. The split conversion rule may be preconfigured, and the above split conversion rule is fixed and the same regardless of the type of computation graph.

The number of conversion functions corresponding to the n^{th} target input tensor may be one or more; the relevant information of the conversion function may include at least one of: the type of the conversion function, the name of the conversion function, and the input parameter of the conversion function, where the input parameter of the conversion function may include at least one of: input address, input size, communication group (which may be represented as Communicator). The communication group may be an abstraction of a plurality of computing devices. For example, the communication group may be used to indicate or determine one or more computing devices that perform calculation or processing of the conversion function among all the computing devices. In some possible examples, the relevant information of the conversion function may also be referred to as a function signature of the conversion function.

Correspondingly, the relevant information of the conversion function corresponding to the n^{th} target input tensor may include at least one of: the type of each of one or more conversion functions corresponding to the n^{th} target input tensor, the input parameter of each conversion function corresponding to the n^{th} target input tensor, and so on.

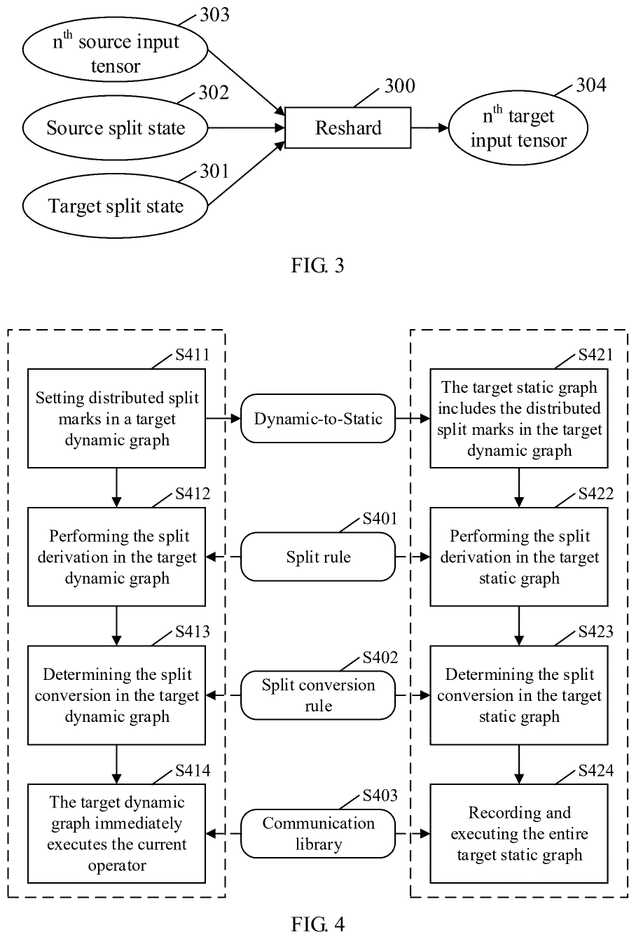

In combination with FIG. 3, assuming that the conversion function corresponding to the n^{th} target input tensor is represented as Reshard 300, the function of the Reshard is to be able to convert the target split state 301 of the input n^{th} target input tensor (for example, represented as dst (destination)-Disattr-n), the source split state 302 of the n^{th} source input tensor (for example, represented as src (source)-Disattr-n), and the n^{th} source input tensor 303 (for example, represented as src-tensor-n) into the output n^{th} target input tensor 304 (for example, represented as dst-tensor-n).

The n^{th} target input tensor is any one of all target input tensors of the first operator. The same processing is performed on each target input tensor, and thus will not be described one by one. That is to say, the target split state of each target input tensor derived above can be converted and mapped into an actually executable communication operator by the processing provided in this embodiment. The target split state (such as including the distributed mark set by the user) obtained in the above processing is a data structure description in an abstract programming language. The combination of such abstract descriptions is diverse, but the communication operator corresponding to each group of fixed descriptions is fixed. By executing the method provided in this embodiment, a fixed split state can be combined with a conversion function in either the target static graph or the target dynamic graph, and a correct conversion function can be inserted into the target computation graph.

In some possible implementations, the step of splitting each source input tensor of the first operator based on the relevant information of the conversion function corresponding to each target input tensor to obtain each target input tensor includes: calling the conversion function corresponding to each target input tensor from a function library by a call stack corresponding to the target computation graph based on the relevant information of the conversion function corresponding to each target input tensor; and processing each source input tensor of the first operator based on the conversion function corresponding to each target input tensor to obtain each target input tensor.

A plurality of candidate functions and the related information of each candidate function are stored or pre-configured in the function library. Different candidate functions among the plurality of candidate functions can be used to perform different processing. The underlying layer of the candidate function is the collective communication primitive, which is itself a static function. The relevant information of each candidate function may include the same content as in the aforementioned embodiments, such as at least one of type, input parameter, etc., which will not be elaborated. The relevant information of each candidate function can enable each candidate function to present the same interface to the outside (such as a target dynamic graph or a target static graph). In this way, a function library (which can be called a communication library or a communication operator library) that can be called in both dynamic and static graphs can be implemented, and the candidate functions in the function library can be correctly called regardless of whether the target computation graph is a static or dynamic graph.

For example, the candidate functions may include at least one of: allreduce( ) (i.e., allreduce function) for performing reduction operations across multiple processes or multiple computing devices and/or broadcasting reduction results to multiple processes or multiple computing devices; allgather( ) (i.e., allgather function) for gathering data from all processes or all computing devices and/or sending the gathered data to all processes or all computing devices; send( ) (i.e., send function) for sending data; recv( ) (i.e., receive function) for receiving data; concat( ) (i.e., concatenate function) for connecting or merging two or more arrays, strings or other types of objects; split( ) (i.e., split function) for splitting a string according to a specified delimiter and/or returning a list containing the split sub-strings; reduce scatter( ) (i.e., reduce scatter function) for performing a reduction operation on a group of input tensors or arrays and scattering the reduced results into the output tensors or arrays, and so on.

It should be understood that the above is only a schematic illustration of the plurality of candidate functions stored or pre-configured in the function library. In actual processing, the function library may include but is not limited to the types of several candidate functions exemplified above, but this embodiment does not limit or exhaustively list them. In addition, this embodiment does not limit the underlying implementation method or underlying implementation logic or code of each of the above candidate functions.

The step of calling the conversion function corresponding to each target input tensor from the function library by the call stack corresponding to the target computation graph based on the relevant information of the conversion function corresponding to each target input tensor may mean: calling each conversion function matching with the relevant information of the conversion function among a plurality of candidate functions stored in the function library by the call stack corresponding to the target computation graph based on the relevant information of the conversion function corresponding to the n^{th} target input tensor. The conversion function corresponding to each target input tensor of the first operator is called in the same way as the n^{th} target input tensor, and thus will not be described one by one.

Through the above processing, the corresponding conversion function can be correctly called from the function library through the same relevant information of the conversion function corresponding to the target input tensor regardless of whether the target computation graph is a dynamic or static graph, thereby ensuring the uniformity of subsequent execution of distributed parallel communication regardless of whether the target computation graph is a dynamic or static graph.

The following takes the target computation graph as one of the two types (static and dynamic) as an example to provide exemplary illustration.

In one embodiment, the step of splitting each source input tensor of the first operator based on the conversion function corresponding to each target input tensor to obtain each target input tensor includes: when the target computation graph is a dynamic computation graph, obtaining a first conversion function corresponding to each target input tensor based on the conversion function and a dynamic encapsulation parameter corresponding to each target input tensor; and splitting each source input tensor of the first operator based on the first conversion function corresponding to each target input tensor to obtain each target input tensor.

Here, the dynamic encapsulation parameter may be configured according to actual conditions, and the dynamic encapsulation parameter may be set so that the call stack corresponding to the target dynamic computation graph can correctly execute or call the corresponding function. In some possible examples, the dynamic encapsulation parameter may include a device management parameter (for example, expressed as Device Manager), and all contents that may be included in the dynamic encapsulation parameter are not limited or enumerated here.

The step of obtaining the first conversion function based on the conversion function and the dynamic encapsulation parameter corresponding to each target input tensor may be: encapsulating the conversion function corresponding to the n^{th} target input tensor with the dynamic encapsulation parameter to obtain the first conversion function corresponding to the n^{th} target input tensor.

The step of splitting each source input tensor of the first operator based on the first conversion function to obtain each target input tensor may be: inputting the n^{th} source input tensor into the first conversion function corresponding to the n^{th} target input tensor, and splitting the n^{th} target input tensor by one or more conversion functions contained in the first conversion function corresponding to the n^{th} target input tensor to obtain the n^{th} target input tensor. After the above processing, the n^{th} target input tensor obtained is an input tensor satisfying its corresponding target split state.

In one embodiment, the step of splitting each source input tensor of the first operator based on the conversion function corresponding to each target input tensor to obtain each target input tensor includes: when the target computation graph is a static computation graph, obtaining a second conversion function corresponding to each target input tensor based on the conversion function and a static encapsulation parameter corresponding to each target input tensor; and splitting each source input tensor of the first operator based on the second conversion function corresponding to each target input tensor to obtain each target input tensor.

Here, the static encapsulation parameter may be configured according to actual conditions, and the static encapsulation parameter may be set so that the call stack corresponding to the static computation graph can correctly execute or call the corresponding function. In some possible examples, the static encapsulation parameter may be computing device context (for example, expressed as Device Context), and all contents that may be included in the static encapsulation parameter are not limited or enumerated here.

The step of obtaining the second conversion function corresponding to each target input tensor based on the conversion function and the static encapsulation parameter corresponding to each target input tensor may be: encapsulating the conversion function corresponding to the n^{th} target input tensor with the static encapsulation parameter to obtain the second conversion function corresponding to the n^{th} target input tensor.

The step of splitting each source input tensor of the first operator based on the second conversion function corresponding to each target input tensor to obtain each target input tensor may be: inputting the n^{th} source input tensor into the second conversion function corresponding to the n^{th} target input tensor, and splitting the n^{th} target input tensor by one or more conversion functions contained in the second conversion function corresponding to the n^{th} target input tensor to obtain the n^{th} target input tensor.

It should be pointed out that the n^{th} target input tensor may include a plurality of split input tensors no matter in the target static graph or the target dynamic graph in the above two embodiments. The step of sending each target input tensor to the plurality of computing devices and the subsequent processing may be: after obtaining a plurality of split input tensors included in the n^{th} target input tensor of the first operator, the electronic device sends the plurality of split input tensors included in the n^{th} target input tensor respectively to each computing device among the plurality of computing devices that perform distributed parallel communication; when receiving at least part of the output tensors of the first operator sent by each computing device, the electronic device merges (for example, directly merges or computationally merges, etc.) at least part of the output tensors corresponding to the first operator sent by each computing device to obtain the output tensor corresponding to the first operator. Correspondingly, after each computing device among the plurality of computing devices receives the respective corresponding split input tensor, each computing device can input the received split input tensor into the first operator to calculate at least some output tensors corresponding to each computing device, and then each computing device sends at least some output tensors corresponding to the first operator obtained by itself to the electronic device.

Alternatively, the step of sending each target input tensor to the plurality of computing devices and the subsequent processing may be: the electronic device sends the plurality of split input tensors included in the n^{th} target input tensor respectively to each computing device among the plurality of computing devices that perform distributed parallel communication; and correspondingly, after receiving the corresponding split input tensor, each computing device may input the received split input tensor into the first operator to calculate at least some output tensors corresponding to each computing device, and each computing device uses at least some output tensors corresponding to the first operator obtained by itself to perform the related calculation of a downstream operator. Whether to merge at least some output tensors of the first operator is related to at least one of the requirement of the downstream operator, the calculation logic of the downstream operator, the split state of the input tensor of the downstream operator, etc., which will not be limited or exhaustive in this embodiment.

Furthermore, if the plurality of computing devices include an electronic device, then the electronic device can perform a part of calculation by itself, and the remaining computing devices can perform other parts of calculation, which is also within the protection scope of this embodiment and is not limited or exhaustive here.

Further, each target input tensor can be input into the first operator to obtain the output tensor of the first operator regardless of whether the target computation graph is a target static computation graph or a target dynamic computation graph, where the generation method of each target input tensor is the same as the generation method of the n^{th} target input tensor described above, and will not be repeated. Since the same conversion function is used to perform the same processing on the same target input tensor regardless of whether the target computation graph is a target static computation graph or a target dynamic computation graph, the same output tensor of the first operator can be obtained regardless of whether the target computation graph is a target static computation graph or a target dynamic computation graph.

Through the above solution, although different static or dynamic parameters used by the encapsulation are added when the target computation graph is a static computation graph and a dynamic computation graph respectively, the underlying conversion function is essentially the same. In this way, when the target computation graph is a static computation graph and a dynamic computation graph respectively, different encapsulation conversions are performed so that the same underlying function can match the call stack of the static computation graph and the call stack of the dynamic computation graph respectively, so as to use the same conversion function to obtain the same tensor split result when the target computation graph is the static computation graph and the dynamic computation graph respectively, thereby ensuring that a unified result is finally executed and obtained regardless of whether the target computation graph is in the static or dynamic type.

In some possible implementations, after deriving the split state of the output tensor of the first operator, the method further includes: when the output tensor of the first operator is a j^{th} source input tensor among one or more source input tensors of a second operator in the target computation graph, taking the split state of the output tensor of the first operator as a source split state of the j^{th} source input tensor of the second operator, where j is an integer not less than 1. Combined with different types of target computation graphs:

In one example, the target computation graph is a target dynamic computation graph. In this case, after each target input tensor is input into the first operator to obtain the output tensor of the first operator, and when a downstream operator of the first operator is set in the target dynamic computation graph and the output tensor of the first operator is set as the j^{th} source input tensor among one or more source input tensors of the current operator, the split state of the output tensor of the first operator is used as the source split state of the j^{th} source input tensor of the second operator.

In one example, the target computation graph is a target static computation graph. In this case, after the target split states of one or more target input tensors of the first operator are derived and the split state of the output tensor of the first operator is derived, and when a downstream operator of the first operator is included in the target static computation graph and the output tensor of the first operator is used as the j^{th} source input tensor among one or more source input tensors of the downstream operator, the downstream operator is used as a second operator, and the split state of the output tensor of the first operator is used as the source split state of the j^{th} source input tensor of the second operator.

It should also be noted that the number of output tensors of the first operator may be one or more regardless of whether the target computation graph is of static or dynamic type. When the first operator has a plurality of output tensors, and when the m^{th} output tensor of the first operator is the j^{th} source input tensor among the one or more source input tensors of the second operator in the target computation graph, the split state of the m^{th} output tensor of the first operator is used as the source split state of the j^{th} source input tensor of the second operator, where m is an integer not less than 1, and the m^{th} output tensor is any one of the plurality of output tensors of the first operator.

For example, with reference to FIG. 2, the process for the first operator 200 to obtain the output tensor C 231 has been described in detail in the above embodiment and will not be described in detail. The output tensor C of the first operator 200 is used as one source input tensor C of the downstream operator, i.e., the second operator 240. The split state of the output tensor C may be directly used as the source split state of the source input tensor C of the second operator 240. Further, the second operator 240 also includes another source input tensor D 241, and the source input tensor D may have no distributed split mark set by the user (and may be set to the default split state). Similarly, the corresponding target split state may be determined for each source input tensor of the second operator, and finally the target input tensor C′ 232 and the target input tensor D′ 242 may be obtained by conversion. The second operator may obtain an output tensor E 250.

Through the above solution, the source split state of any source input tensor of the downstream operator of the first operator can be determined based on the split state of the output tensor of the first operator regardless of whether the target computation graph is a static computation graph or a dynamic computation graph, thus ensuring that the split state corresponding to each tensor is set in the same way when the target computation graph is a static computation graph or a dynamic computation graph.

In conjunction with FIG. 4, an exemplary description of the tensor processing method provided in this embodiment is given:

S411: during single card networking (model networking) of a target dynamic graph, a user sets a current operator (such as the first operator in the aforementioned embodiments) and may set the distributed split marks of at least part of the source input tensors of the current operator. For example, the source split states of at least part of the source input tensors of the current operator are obtained based on the distributed split marks of at least part of the source input tensors of the current operator; and/or, any one or more output tensors of any one or more upstream operators of the current operator and their corresponding split states are used as one or more source input tensors of the current operator and their corresponding source split states.

S412: performing the split derivation in the target dynamic graph. For example, the target split states of one or more target input tensors of the current operator and the split state of the output tensor of the current operator are derived based on the computation logic of the current operator, the source split states of at least part of the source input tensors of the current operator, and the split rule 401 (such as the preset split constraint of the current operator).

S413: determining the split conversion in the target dynamic graph. For example, the relevant information of the conversion function corresponding to each of one or more target input tensors of the current operator is determined based on the split conversion rule 402 and the target split states of one or more target input tensors of the current operator.

S414: the target dynamic graph immediately executes the current operator. The target dynamic graph executes the current operator through the corresponding call stack, for example, calls the conversion function corresponding to each target input tensor from the communication library 403 based on the relevant information of the conversion function corresponding to each target input tensor of the current operator; obtains the first conversion function corresponding to each target input tensor based on the conversion function and dynamic encapsulation parameter corresponding to each target input tensor of the current operator; splits each source input tensor of the current operator based on the first conversion function corresponding to each target input tensor of the current operator to obtain each target input tensor; and performs distributed parallel communication in a plurality of computing devices based on each target input tensor and the current operator, to obtain the output tensor of the first operator.

Each time a new operator is set in the target dynamic graph, the above S411 to S414 can be repeatedly executed. Finally, a plurality of operators after model networking can be obtained in the target dynamic graph. Then, the dynamic-to-static processing may be selected and executed according to actual requirements. The relevant processing flow includes:

S421: performing the dynamic-to-static processing on the target dynamic graph to obtain a target static graph, where the target static graph includes the distributed split marks in the target dynamic graph, and the target static graph may include a plurality of operators in the target dynamic graph.

S422: performing the split derivation in the target static graph. For example, the target split states of one or more target input tensors of each operator among the plurality of operators and the split state of the output tensor of each operator are derived based on the computation logic of each operator, the source split states of at least part of the source input tensors of each operator, and the split rule 401 (such as the preset split constraint of each operator).

S423: determining the split conversion in the target static graph. For example, the relevant information of the conversion function corresponding to each of one or more target input tensors of each operator among the plurality of operators is determined based on the split conversion rule 402 and the target split states of one or more target input tensors of each operator.

S424: recording and executing the entire target static graph. Specifically, a plurality of operators, the target split state of each target input tensor of each operator, and the conversion function corresponding to each target input tensor of each operator contained in the entire graph are recorded in the target static graph; and then the target static graph is executed as a whole. The target static graph executes the plurality of operators in the entire graph through its corresponding call stack. It should be noted that the target static graph can execute each operator in sequence based on the dependency relationship among the operators in the entire graph. The processing when executing any current operator is similar to the above S414 and will not be repeated.

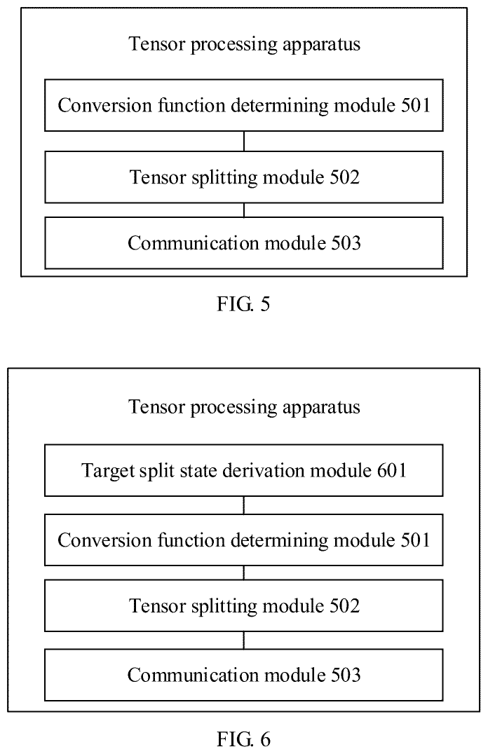

FIG. 5 shows a schematic block diagram of a tensor processing apparatus according to an embodiment of the present disclosure. As shown in FIG. 5, the apparatus includes:
a conversion function determining module 501 configured to determine relevant information of a conversion function corresponding to each of one or more target input tensors of a first operator in a target computation graph based on computation logic of the first operator and source split states of at least part of source input tensors of the first operator, where relevant information of a conversion function corresponding to any of the one or more target input tensors is constant when the target computation graph is a computation graph in different types;
a tensor splitting module 502 configured to split each source input tensor of the first operator based on the relevant information of the conversion function corresponding to each target input tensor to obtain each target input tensor; and
a communication module 503 configured to send each target input tensor to a plurality of computing devices, where the plurality of computing devices are configured to perform distributed parallel communication based on each target input tensor and the first operator, to obtain an output tensor of the first operator.

As shown in FIG. 6, the apparatus further includes:
a target split state derivation module 601 configured to derive a target split state of each of the one or more target input tensors of the first operator based on the computation logic of the first operator in the target computation graph and the source split states of at least part of the source input tensors of the first operator;
where the conversion function determining module is configured to determine the relevant information of the conversion function corresponding to each target input tensor of the first operator based on the target split state of each target input tensor of the first operator.

The target split state derivation module is configured to derive the target split state of each of the one or more target input tensors of the first operator and a split state of the output tensor of the first operator based on the computation logic of the first operator, the source split states of at least part of the source input tensors of the first operator and a preset split constraint of the first operator in the target computation graph, where the preset split constraint of the first operator is constant when the target computation graph is a computation graph in different types, and the preset split constraint of the first operator includes at least one of: target split states of the one or more target input tensors satisfy a computation requirement of the first operator, and an efficiency requirement for distributed parallel communication is performed based on the target split states of the one or more target input tensors of the first operator.

The target split state derivation module is configured to, when the output tensor of the first operator is a j^{th} source input tensor among one or more source input tensors of a second operator in the target computation graph, take the split state of the output tensor of the first operator as a source split state of the j^{th} source input tensor of the second operator, where j is an integer not less than 1.

The tensor splitting module is configured to call the conversion function corresponding to each target input tensor from a function library by a call stack corresponding to the target computation graph based on the relevant information of the conversion function corresponding to each target input tensor; and split each source input tensor of the first operator based on the conversion function corresponding to each target input tensor to obtain each target input tensor.

The tensor splitting module is configured to, when the target computation graph is a dynamic computation graph, obtain a first conversion function corresponding to each target input tensor based on the conversion function and a dynamic encapsulation parameter corresponding to each target input tensor; and split each source input tensor of the first operator based on the first conversion function corresponding to each target input tensor to obtain each target input tensor.

The tensor splitting module is configured to, when the target computation graph is a static computation graph, obtain a second conversion function corresponding to each target input tensor based on the conversion function and a static encapsulation parameter corresponding to each target input tensor; and split each source input tensor of the first operator based on the second conversion function corresponding to each target input tensor to obtain each target input tensor.

The target split state derivation module is configured to perform one of:
when the target computation graph is a dynamic computation graph, in response to obtaining a distributed split mark set for an i^{th} source input tensor of the first operator, obtaining a source split state of the i^{th} source input tensor of the first operator based on the distributed split mark corresponding to the i^{th} source input tensor of the first operator, where i is an integer not less than 1, and the i^{th} source input tensor is one of at least part of the source input tensors; and
when the target computation graph is the dynamic computation graph, in response to setting a k^{th} output tensor of a third operator in the target computation graph as the i^{th} source input tensor of the first operator, taking a split state corresponding to the k^{th} output tensor of the third operator as the source split state of the i^{th} source input tensor of the first operator, where k is an integer not less than 1.

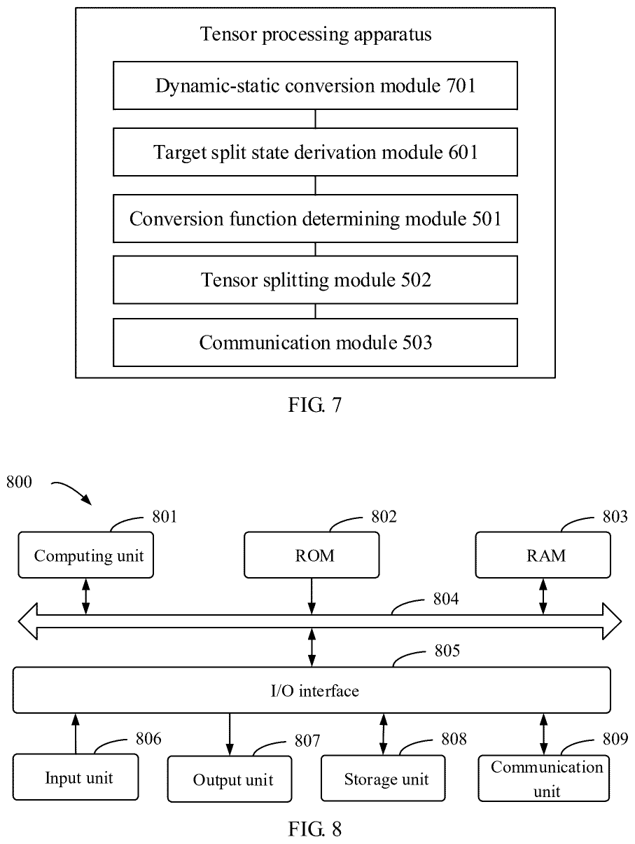

As shown in FIG. 7, the type of the target computation graph is a static computation graph; and the apparatus further includes:
a dynamic-static conversion module 701 configured to generate the target computation graph based on an original dynamic computation graph in response to obtaining a static conversion instruction under the original dynamic computation graph, where the target computation graph and the original dynamic computation graph contain a plurality of same operators and distributed split marks of one or more source input tensors of the plurality of operators, and the plurality of operators include the first operator.

The target split state derivation module is configured to perform one of:
when an i^{th} source input tensor of the first operator has a corresponding distributed split mark, obtaining a source split state of the i^{th} source input tensor of the first operator based on the distributed split mark corresponding to the i^{th} source input tensor of the first operator, where i is an integer not less than 1, and the i^{th} source input tensor is one of at least part of the source input tensors; and
when the i^{th} source input tensor of the first operator in the target computation graph is a k^{th} output tensor of a third operator, taking a split state corresponding to the k^{th} output tensor of the third operator as the source split state of the i^{th} source input tensor of the first operator, where k is an integer not less than 1.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 8 shows a schematic block diagram of an exemplary electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the electronic device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for the operations of the electronic device 800 may also be stored in the RAM 803. The computing unit 801, the ROM 802 and the RAM 803 are connected to each other through a bus 804. The input/output (I/O) interface 805 is also connected to the bus 804.

A plurality of components in the electronic device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the electronic device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processing described above. For example, in some implementations, the various methods may be implemented as a computer software program tangibly contained in a computer-readable medium, such as the storage unit 808. In some implementations, a part or all of the computer program may be loaded and/or installed on the electronic device 800 via the ROM 802 and/or the communication unit 809. When the computer program is loaded into the RAM 803 and executed by the computing unit 801, one or more steps of the method described above may be performed. Alternatively, in other implementations, the computing unit 801 may be configured to perform the method by any other suitable means (e.g., by means of firmware).

According to another aspect of the present disclosure, an autonomous driving vehicle is provided, including the electronic device described above.

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A tensor processing method, comprising:
determining relevant information of a conversion function corresponding to each of one or more target input tensors of a first operator in a target computation graph based on computation logic of the first operator and source split states of at least part of source input tensors of the first operator, wherein relevant information of a conversion function corresponding to any of the one or more target input tensors is constant when the target computation graph is a computation graph in different types;
splitting each source input tensor of the first operator based on the relevant information of the conversion function corresponding to each target input tensor to obtain each target input tensor; and
sending each target input tensor to a plurality of computing devices, wherein the plurality of computing devices are configured to perform distributed parallel communication based on each target input tensor and the first operator, to obtain an output tensor of the first operator.

2. The method of claim 1, wherein the determining relevant information of a conversion function corresponding to each of one or more target input tensors of a first operator in a target computation graph based on computation logic of the first operator and source split states of at least part of source input tensors of the first operator, comprises:
deriving a target split state of each of the one or more target input tensors of the first operator based on the computation logic of the first operator in the target computation graph and the source split states of at least part of the source input tensors of the first operator; and
determining the relevant information of the conversion function corresponding to each target input tensor of the first operator based on the target split state of each target input tensor of the first operator.

3. The method of claim 2, wherein the deriving a target split state of each of the one or more target input tensors of the first operator based on the computation logic of the first operator in the target computation graph and the source split states of at least part of the source input tensors of the first operator, comprises:
deriving the target split state of each of the one or more target input tensors of the first operator and a split state of the output tensor of the first operator based on the computation logic of the first operator, the source split states of at least part of the source input tensors of the first operator and a preset split constraint of the first operator in the target computation graph, wherein the preset split constraint of the first operator is constant when the target computation graph is a computation graph in different types, and the preset split constraint of the first operator comprises at least one of: target split states of the one or more target input tensors satisfy a computation requirement of the first operator, and an efficiency requirement for distributed parallel communication is performed based on the target split states of the one or more target input tensors of the first operator.

4. The method of claim 3, wherein after deriving the split state of the output tensor of the first operator, the method further comprises:
when the output tensor of the first operator is a j^{th} source input tensor among one or more source input tensors of a second operator in the target computation graph, taking the split state of the output tensor of the first operator as a source split state of the j^{th} source input tensor of the second operator, wherein j is an integer not less than 1.

5. The method of claim 1, wherein the splitting each source input tensor of the first operator based on the relevant information of the conversion function corresponding to each target input tensor to obtain each target input tensor, comprises:
calling the conversion function corresponding to each target input tensor from a function library by a call stack corresponding to the target computation graph based on the relevant information of the conversion function corresponding to each target input tensor; and
splitting each source input tensor of the first operator based on the conversion function corresponding to each target input tensor to obtain each target input tensor.

6. The method of claim 5, wherein the splitting each source input tensor of the first operator based on the conversion function corresponding to each target input tensor to obtain each target input tensor, comprises:
when the target computation graph is a dynamic computation graph, obtaining a first conversion function corresponding to each target input tensor based on the conversion function and a dynamic encapsulation parameter corresponding to each target input tensor; and
splitting each source input tensor of the first operator based on the first conversion function corresponding to each target input tensor to obtain each target input tensor.

7. The method of claim 5, wherein the splitting each source input tensor of the first operator based on the conversion function corresponding to each target input tensor to obtain each target input tensor, comprises:
when the target computation graph is a static computation graph, obtaining a second conversion function corresponding to each target input tensor based on the conversion function and a static encapsulation parameter corresponding to each target input tensor; and
splitting each source input tensor of the first operator based on the second conversion function corresponding to each target input tensor to obtain each target input tensor.

8. The method of claim 1, wherein before determining the relevant information of the conversion function corresponding to each of one or more target input tensors of the first operator in the target computation graph based on the computation logic of the first operator and the source split states of at least part of the source input tensors of the first operator, the method further comprises at least one of:
when the target computation graph is a dynamic computation graph, in response to obtaining a distributed split mark set for an i^{th} source input tensor of the first operator, obtaining a source split state of the i^{th} source input tensor of the first operator based on the distributed split mark corresponding to the i^{th} source input tensor of the first operator, wherein i is an integer not less than 1, and the i^{th} source input tensor is one of at least part of the source input tensors; and
when the target computation graph is the dynamic computation graph, in response to setting a k^{th} output tensor of a third operator in the target computation graph as the i^{th} source input tensor of the first operator, taking a split state corresponding to the k^{th} output tensor of the third operator as the source split state of the i^{th} source input tensor of the first operator, wherein k is an integer not less than 1.

9. The method of claim 1, wherein the target computation graph is a static computation graph; and
the method further comprises: generating the target computation graph based on an original dynamic computation graph in response to obtaining a static conversion instruction under the original dynamic computation graph, wherein the target computation graph and the original dynamic computation graph contain a plurality of same operators and distributed split marks of one or more source input tensors of the plurality of operators, and the plurality of operators comprise the first operator.

10. The method of claim 9, wherein before determining the relevant information of the conversion function corresponding to each of one or more target input tensors of the first operator in the target computation graph based on the computation logic of the first operator and the source split states of at least part of the source input tensors of the first operator, the method further comprises at least one of:
when an i^{th} source input tensor of the first operator has a corresponding distributed split mark, obtaining a source split state of the i^{th} source input tensor of the first operator based on the distributed split mark corresponding to the i^{th} source input tensor of the first operator, wherein i is an integer not less than 1, and the i^{th} source input tensor is one of at least part of the source input tensors; and
when the i^{th} source input tensor of the first operator in the target computation graph is a k^{th} output tensor of a third operator, taking a split state corresponding to the k^{th} output tensor of the third operator as the source split state of the i^{th} source input tensor of the first operator, wherein k is an integer not less than 1.

11. An electronic device, comprising:
at least one processor; and
a memory connected in communication with the at least one processor;
wherein the memory stores an instruction executable by the at least one processor, and the instruction, when executed by the at least one processor, enables the at least one processor to execute following operations:
determining relevant information of a conversion function corresponding to each of one or more target input tensors of a first operator in a target computation graph based on computation logic of the first operator and source split states of at least part of source input tensors of the first operator, wherein relevant information of a conversion function corresponding to any of the one or more target input tensors is constant when the target computation graph is a computation graph in different types;
splitting each source input tensor of the first operator based on the relevant information of the conversion function corresponding to each target input tensor to obtain each target input tensor; and
sending each target input tensor to a plurality of computing devices, wherein the plurality of computing devices are configured to perform distributed parallel communication based on each target input tensor and the first operator, to obtain an output tensor of the first operator.

12. The electronic device of claim 11, wherein the determining relevant information of a conversion function corresponding to each of one or more target input tensors of a first operator in a target computation graph based on computation logic of the first operator and source split states of at least part of source input tensors of the first operator, comprises:
deriving a target split state of each of the one or more target input tensors of the first operator based on the computation logic of the first operator in the target computation graph and the source split states of at least part of the source input tensors of the first operator; and
determining the relevant information of the conversion function corresponding to each target input tensor of the first operator based on the target split state of each target input tensor of the first operator.

13. The electronic device of claim 12, wherein the deriving a target split state of each of the one or more target input tensors of the first operator based on the computation logic of the first operator in the target computation graph and the source split states of at least part of the source input tensors of the first operator, comprises:
deriving the target split state of each of the one or more target input tensors of the first operator and a split state of the output tensor of the first operator based on the computation logic of the first operator, the source split states of at least part of the source input tensors of the first operator and a preset split constraint of the first operator in the target computation graph, wherein the preset split constraint of the first operator is constant when the target computation graph is a computation graph in different types, and the preset split constraint of the first operator comprises at least one of: target split states of the one or more target input tensors satisfy a computation requirement of the first operator, and an efficiency requirement for distributed parallel communication is performed based on the target split states of the one or more target input tensors of the first operator.

14. The electronic device of claim 13, wherein after deriving the split state of the output tensor of the first operator, the operations further comprise:
when the output tensor of the first operator is a j^{th} source input tensor among one or more source input tensors of a second operator in the target computation graph, taking the split state of the output tensor of the first operator as a source split state of the j^{th} source input tensor of the second operator, wherein j is an integer not less than 1.

15. The electronic device of claim 11, wherein the splitting each source input tensor of the first operator based on the relevant information of the conversion function corresponding to each target input tensor to obtain each target input tensor, comprises:
calling the conversion function corresponding to each target input tensor from a function library by a call stack corresponding to the target computation graph based on the relevant information of the conversion function corresponding to each target input tensor; and
splitting each source input tensor of the first operator based on the conversion function corresponding to each target input tensor to obtain each target input tensor.

16. A non-transitory computer-readable storage medium storing a computer instruction thereon, wherein the computer instruction is used to cause a computer to execute following operations:
determining relevant information of a conversion function corresponding to each of one or more target input tensors of a first operator in a target computation graph based on computation logic of the first operator and source split states of at least part of source input tensors of the first operator, wherein relevant information of a conversion function corresponding to any of the one or more target input tensors is constant when the target computation graph is a computation graph in different types;
splitting each source input tensor of the first operator based on the relevant information of the conversion function corresponding to each target input tensor to obtain each target input tensor; and
sending each target input tensor to a plurality of computing devices, wherein the plurality of computing devices are configured to perform distributed parallel communication based on each target input tensor and the first operator, to obtain an output tensor of the first operator.

17. The non-transitory computer-readable storage medium of claim 16, wherein the determining relevant information of a conversion function corresponding to each of one or more target input tensors of a first operator in a target computation graph based on computation logic of the first operator and source split states of at least part of source input tensors of the first operator, comprises:
deriving a target split state of each of the one or more target input tensors of the first operator based on the computation logic of the first operator in the target computation graph and the source split states of at least part of the source input tensors of the first operator; and
determining the relevant information of the conversion function corresponding to each target input tensor of the first operator based on the target split state of each target input tensor of the first operator.

18. The non-transitory computer-readable storage medium of claim 17, wherein the deriving a target split state of each of the one or more target input tensors of the first operator based on the computation logic of the first operator in the target computation graph and the source split states of at least part of the source input tensors of the first operator, comprises:
deriving the target split state of each of the one or more target input tensors of the first operator and a split state of the output tensor of the first operator based on the computation logic of the first operator, the source split states of at least part of the source input tensors of the first operator and a preset split constraint of the first operator in the target computation graph, wherein the preset split constraint of the first operator is constant when the target computation graph is a computation graph in different types, and the preset split constraint of the first operator comprises at least one of: target split states of the one or more target input tensors satisfy a computation requirement of the first operator, and an efficiency requirement for distributed parallel communication is performed based on the target split states of the one or more target input tensors of the first operator.

19. The non-transitory computer-readable storage medium of claim 18, wherein after deriving the split state of the output tensor of the first operator, the operations further comprise:
when the output tensor of the first operator is a j^{th} source input tensor among one or more source input tensors of a second operator in the target computation graph, taking the split state of the output tensor of the first operator as a source split state of the j^{th} source input tensor of the second operator, wherein j is an integer not less than 1.

20. The non-transitory computer-readable storage medium of claim 16, wherein the splitting each source input tensor of the first operator based on the relevant information of the conversion function corresponding to each target input tensor to obtain each target input tensor, comprises:
calling the conversion function corresponding to each target input tensor from a function library by a call stack corresponding to the target computation graph based on the relevant information of the conversion function corresponding to each target input tensor; and
splitting each source input tensor of the first operator based on the conversion function corresponding to each target input tensor to obtain each target input tensor.
